(19) United States
(12) Patent Application Publication
(10) Pub. No.: US 2026/0110242 A1
(43) Pub. Date: Apr. 23, 2026

(54) ELECTRICAL SUBMERSIBLE PUMP CABLE INSPECTION WITH COMPUTER VISION

(71) Applicant: Halliburton Energy Services, Inc., Houston, TX (US)

(72) Inventors: Travis Chet JOHNSON, Tulsa, OK (US); Terry GLASSCOCK, Tulsa, OK (US); Christina Marie HARRINGTON, Tulsa, OK (US); Jeffrey BRIDGES, Tulsa, OK (US)

(73) Assignee: Halliburton Energy Services, Inc., Houston, TX (US)

(21) Appl. No.: 18/924,380

(22) Filed: Oct. 23, 2024

(51) Int. Cl. E21B 47/002; E21B 47/00; G06T 7/00; G06T 7/70; G08B 21/18

(52) U.S. Cl. CPC E21B 47/002; E21B 47/006; G06T 7/0002; G06T 7/70; G08B 21/18; E21B 2200/20; G06T 2207/20081

(57) ABSTRACT

Aspects of the subject technology relate to systems, methods, and computer-readable media for automatically evaluating conditions of a power cable that was deployed in a wellbore. Such power cables may be used to power an electrical submersible pump (ESP). When a power cable is retrieved from a wellbore, cameras or other sensors may be used to collect data as a machine-learning (ML) or artificial intelligent (AI) system performs evaluations on that collected data. This ML or AI system may be trained using data from a cable that is being evaluated. Determinations may be made using data collected by the sensors relating to whether the cable is a good cable or a defective cable. Various criterion may be used when such determinations are made.

### TECHNICAL FIELD

The present disclosure is directed to the inspection of power cables that were deployed in a wellbore. More specifically, the present disclosure is directed to an automated inspection system that examines power cables as they are withdrawn from the wellbore or otherwise moved.

### BACKGROUND

In certain wellbore applications, like geothermal energy generation and oil and gas production, components may be deployed in a wellbore in instances where pumps or other tools must be used. For various reasons, pumps used in wellbore applications must be of a class of pump referred to as an electrical submersible pump (ESP). Such components may be selected based on their ability to withstand environments where they will be deployed or may be selected based on requirements dictated by a particular type of wellbore operation. In order for ESPs to operate, they must be connected to a power source and commonly these power sources are coupled to an ESP using a power cable that is lowered into a wellbore with the pump. Power cables may also be lowered into a wellbore to provide power to other types of tools, and examples of such other tools include sensing apparatus and drills. The extreme conditions of a wellbore may also affect the reliability of power cables that are deployed in the wellbore.

### BRIEF DESCRIPTION OF THE DRAWINGS

In order to describe the manner in which the features and advantages of this disclosure can be obtained, a more particular description is provided with reference to specific embodiments thereof which are illustrated in the appended drawings. Understanding that these drawings depict only exemplary embodiments of the disclosure and are not therefore to be considered limiting of its scope, the principles herein are described and explained with additional specificity and detail through the use of the accompanying drawings.

FIG. 1A, illustrates a schematic representation of a well environment in a production phase, in accordance with various aspects of the subject technology.

FIG. 1B is a schematic diagram of an example downhole environment having tubulars, in accordance with various aspects of the subject technology.

FIGS. 2A and 2B illustrate different power cables that may be used to power an electrically submersible pump or other equipment deployed in a wellbore, in accordance with various aspects of the subject technology.

FIG. 3A illustrates portions of a system that may be used to guide a power cable while cameras or other sensors collect data that may be evaluated to make determinations regarding conditions of the power cable, in accordance with various aspects of the subject technology.

FIG. 3B illustrates a cross-sectional view of a portion of the system illustrated in FIG. 3A, in accordance with various aspects of the subject technology.

FIG. 4 identifies actions that may be performed by a system that evaluates collected data to identify whether a wellbore power cable meets a use criterion, in accordance with various aspects of the subject technology.

FIG. 5 illustrates actions that may be performed by an automated system when that system determines whether an apparent defect in a power cable can be repaired, in accordance with various aspects of the subject technology.

FIG. 6 reviews possible models that can be used to implement a machine-learning or artificial intelligent process, in accordance with various aspects of the subject technology.

FIG. 7 illustrates an example computing device architecture which can be employed to perform any of the systems and techniques described herein.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure may be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Aspects of the subject technology relate to systems, methods, and computer-readable media for automatically evaluating conditions of a power cable that was deployed in a wellbore. Such power cables may be used to power an electrical submersible pump (ESP). When a power cable is retrieved from a wellbore, cameras or other sensors may be used to collect data as a machine-learning (ML) or artificial intelligent (AI) system performs evaluations on that collected data. This ML or AI system may be trained using data from a cable that is being evaluated. Determinations may be made using data collected by the sensors relating to whether the cable is a good cable or a defective cable. Various criterion may be used when such determinations are made.

Electrically submersible pumps (ESPS) are deployed in wellbores where they are used to pump fluids (e.g., drilling muds). Such pumps commonly require high voltage three phase power to power them. Commonly used ESPs have power requirements that range from around 5 thousand Watts (KW) to about 750 KW. Voltages in the range of 460 to 4,200 volts may be used to power such pumps. For various reasons, these voltages are often provided to the motors using a three phase, 60 Hertz (Hz) alternating current (AC) power distribution system. Wires used to distribute these three phase voltages may be built within a single cable assembly. In certain instances, wellbore power cables may have a cylindrical shape. In other instances, wellbore power cables may have a shape that is like a flattened elongated oval tube.

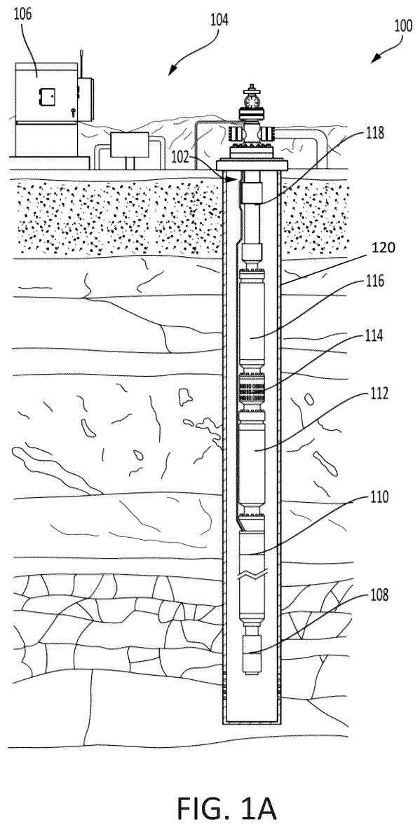

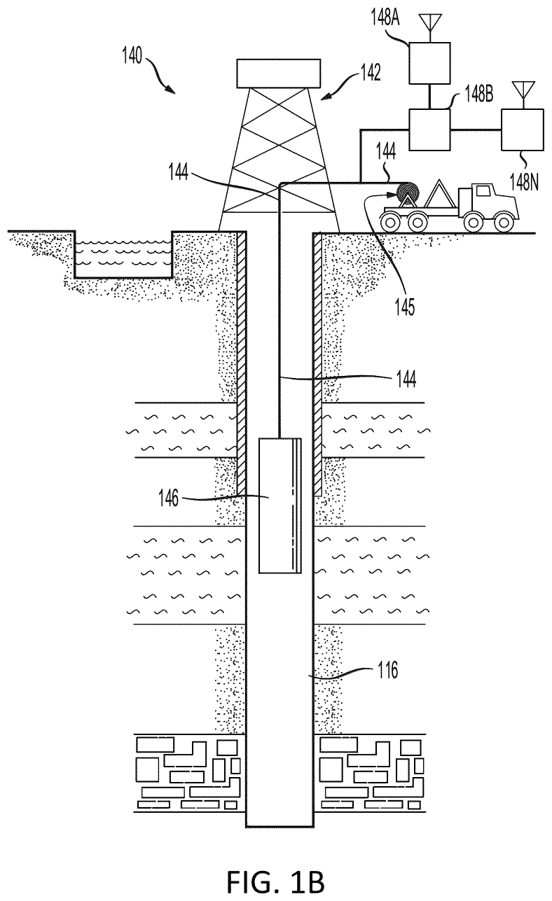

FIG. 1A illustrates a schematic representation of a well environment 100 in a production phase. Well environment 100 can represent an applicable environment in which a substance is pumped through production tubing 118 of a wellbore 120 toward the surface. For example, well environment 100 can represent a hydrocarbon production environment in which hydrocarbons are pumped through production tubing 118 toward the surface. In another example, well environment 100 can represent a geothermal environment in which water/brine is pumped through production tubing 118 toward the surface.

Well environment 100 of FIG. 1A includes production system 104 disposed in relation to wellbore 120. Production system 104 includes a surface control system 106. Production system 104 also includes components disposed downhole in wellbore 120. Specifically, production system 104 includes gauge 108, motor 110, seal section 112, gas separator 114, pump 116, and power cable 102. The components of production system 104, in combination, function to form various tasks related to pumping a substance through production tubing 118 toward the surface. In particular, surface control system 106 functions to control and interact with the various downhole components for performing various tasks related to pumping a substance through production tubing 118 towards the surface.

Gauge 108 functions to generate downhole data of one or more monitored parameters. Specifically, the downhole data can include applicable data that is capable of being measured downhole, for example by one or more sensors. When a first component or first point is described as being before a second component or second point, the first component or point can be positioned further in a wellbore than a second component or point. For example, gauge 108 can include a pressure gauge that is configured to identify a wellbore pressure before pump 116 (e.g. before a pump intake or gas separator). Further, gauge 108 can function to measure parameters for preventing or reducing formation damage caused by over-production through wellbore 120. Gauge 108 can communicate with the surface control system 106 in generating downhole data. Specifically, gauge 108 can provide the downhole data as telemetry data to surface control system 106, where the downhole data can be used in controlling production operation of production system 104.

Motor 110 functions to drive pump 116. Specifically, motor 110 can receive power from the surface through power cable 102 to drive pump 116 in lifting production substance towards the surface. Motor 110 can be an applicable motor that is capable of driving pump 116. Motor 110 and pump 116 may be sealed from the environment when included in an ESP system. Correspondingly, pump 116 can be an applicable pump that is capable of pumping production substances toward the surface of production tubing 118. Seal section 112 is disposed between motor 110 and the intake of pump 116. Seal section 112 functions to isolate motor 110 from downhole fluids. Seal section 112 also can function to equalize pressure in wellbore 120 with pressure in motor 110.

Gas separator 114 is positioned between pump 116 and sealing section 112 and motor 110 combination. Gas separator 114 can serve, at least in part, as an intake for pump 116. In particular, gas separator 114 can function to separate gas from fluid in wellbore 102 and allow for the entry of the separated fluid into pump 116. In turn, pump 116 can pump the separated fluid towards the surface as part of a production substance. The separated fluid that is fed to pump 116 can include portions of the separated gas that are broken down and incorporated into the fluid to form a more homogenized solution.

Applications where ESPs may be used include oil production, natural gas production, geothermal energy production systems, mining, water wells, drilling applications, cementing applications, carbon dioxide (CO₂) sequestration, hydraulic fracturing, or other applications. Each of these different applications may be associated with different environments. Characteristics of various applications include temperature, temperature range, liquid specific gravity, gas specific gravity, measures of corrosivity or acidity (e.g., pH), percent hydrogen sulfide (H₂S), percent CO₂, percent N₂, abrasiveness, viscosity, gas liquid mix ratio, and/or other characteristics.

FIG. 1B is a schematic diagram of an example downhole environment having tubulars, in accordance with various aspects of the subject technology. In this example, an example system 140 is depicted for conducting downhole operations after at least a portion of a wellbore has been drilled and the drill string removed from the well. Various different tools, including an electrically submersible pump can be operated in the example system 140 shown in FIG. 1B. A downhole tool is shown having a tool body 146 in order to carry out wellbore operations. Wireline conveyance 144 can be used to lower tools into a wellbore or retrieve tools from the wellbore. For example, wireline conveyance may be used to move an electrically submersible pump (ESP) along a wellbore. The tool body 146 can be lowered into the wellbore 102 by wireline conveyance 144. The wireline conveyance 144 can be anchored in the drill rig 142 or by a portable means such as a truck 145. The wireline conveyance 144 can include one or more wires, slicklines, cables, and/or the like, as well as tubular conveyances such as coiled tubing, joint tubing, or other tubulars.

The illustrated wireline conveyance 144 may provide power and support for the tool, as well as enabling communication between data processors 148A-N on the surface. In some examples, wireline conveyance 144 can include electrical and/or fiber optic cabling for carrying out communications. The wireline conveyance 144 is sufficiently strong and flexible to tether the tool body 146 through the wellbore 102, while also permitting communication through the wireline conveyance 144 to one or more of the processors 148A-N, which can include local and/or remote processors. The processors 148A-N can be integrated as part of an applicable computing system, such as the computing device architectures described herein. Moreover, power can be supplied via wireline conveyance 144 to meet power requirements of the tool. Wireline conveyance may be or may include a power cable used to provide power to a wellbore tool of tool body 146.

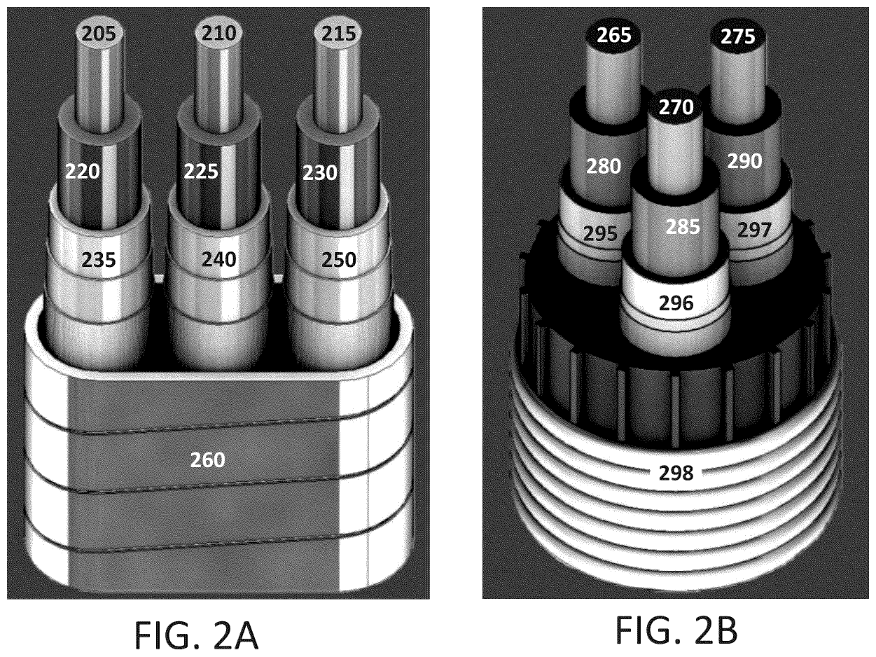

FIGS. 2A and 2B illustrate different power cables that may be used to power an electrically submersible pump or other equipment deployed in a wellbore. FIG. 2A illustrates a three-phase power cable formed in the shape of a flattened elongated oval (or a rectangle with rounded sides). The three-phase power cable of FIG. 2A includes three different conductors or wires 205, 210, and 215. Each of these conductors is surrounded by a first layer (e.g., an insulating layer) and a second layer (e.g., a protective sheath). Here wire 205 has a first layer 220 and a second layer 235, wire 210 has a first layer 225 and a second layer 240, and wire 215 has a first layer 230 and a second layer 250. Wires 205, 210, and 215 and their respective covering layers (e.g., insulation and protective sheaths) are contained with cover 260. Note that cover 260 has the shape of the flattened elongated oval (or rectangle with rounded sides) mentioned above.

The three-phase power cable of FIG. 2B includes three different conductors or wires 265, 270, and 275. Each of these conductors is surrounded by a first layer (e.g., an insulating layer) and a second layer (e.g., a protective sheath). Here wire 265 has a first layer 280 and a second layer 295, wire 270 has a first layer 285 and a second layer 296, and wire 275 has a first layer 290 and a second layer 297. Wires 265, 270, and 275 and their respective covering layers (e.g., insulation and protective sheaths) are contained with cover 298 that has a cylindrical shape.

While not illustrated in FIGS. 2A and 2B, these power cables may have interconnects that physically and electrically connect segments of cable together. Such interconnects may allow the length of a cable deployed in a wellbore to be extended as a tool such as an electrically submersible pump is deployed in the wellbore.

When a tool is removed from the wellbore, an actuation device used to deploy the tool may be used to pull the tool toward the surface. At this time, both a deployment cable and a power cable may be attached to the tool. Alternatively, a single cable may be used to both deploy the tool along the wellbore and power the tool. In either instance, the power cable may be wrapped around a spool as the tool is removed from the wellbore. At this time, the power cable may pass through a series of structures that direct the cable to pass by cameras or other sensors that collect data. This collected data may be interpreted by a system that makes evaluations regarding the quality of the cable. Such a system may be a computer where one or more processors execute instructions of a machine learning (ML) or artificial intelligence (AI) program.

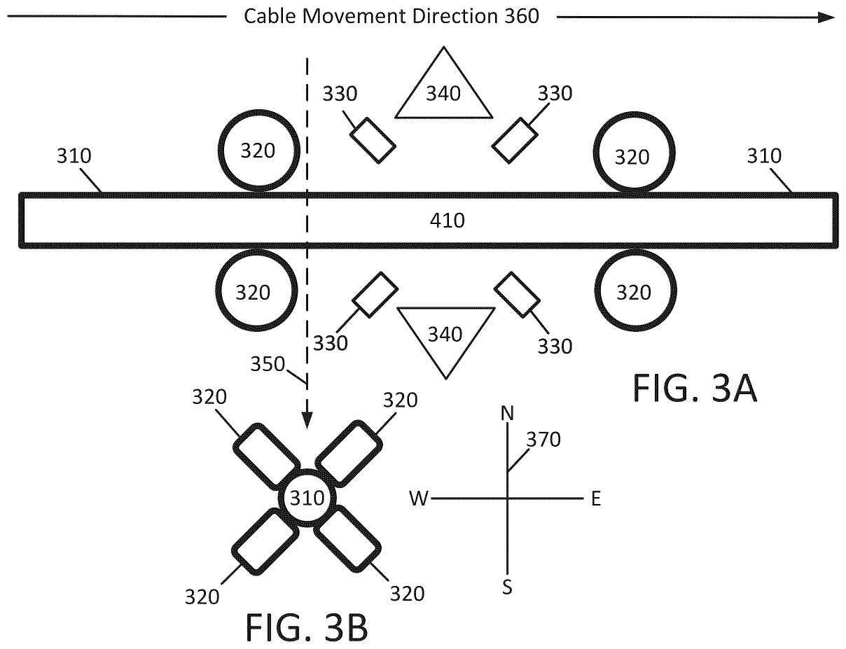

FIG. 3A illustrates portions of a system that may be used to guide a power cable while cameras or other sensors collect data that may be evaluated to make determinations regarding conditions of the power cable. FIG. 3A includes power cable 310, rollers 320, cameras/sensors 330, and devices 340. When power cable 310 is retrieved from a wellbore, it may be guided by rollers 320 past a set of cameras or sensors 330 that collect data as the cable is moved in cable movement direction 360 (e.g., from the left to the right side of FIG. 3A). While not illustrated in FIG. 3A, the left side of cable 310 may be connected to a wellbore tool and the right side of cable 310 may be provided to a spool around which cable 310 is wrapped. Devices 340 may include one or more types of equipment, such as, lights that illuminate cable 310 or may include ultrasonic, Xray image, or electromagnetic data collection devices. In instances where only cameras are used to collect data, cameras 330 may collect image data while illumination is provided by illumination devices 340. Numerous cameras or other sensors 330 may be used to collect data of all surfaces around the diameter or outer portions of cable 310. Different frequencies of light may be used to illuminate cable 310. For example, devices 340 may provide light in one or more of the visible light spectrum, the infrared light spectrum, or the ultraviolet light spectrum.

FIG. 3B illustrates a cross-sectional view of a portion of the system illustrated in FIG. 3A. Dashed line 350 is located at the portion of FIG. 3A that the cross-sectional view of FIG. 3B depicts. FIG. 3B includes four rollers 320 that are disposed to hold cable 310. Rollers 320 may be arranged to pinch and hold cable 310 to minimize motion of cable in directions perpendicular to a center point of cable 310. For example, a center point of cable 310 of FIG. 3B may be constrained to prevent this center point from moving in the directions of North (N), South (S), East (E), and West (W) identified in compass 360 of FIG. 3B. As such, the pinch and hold or clamping effect imposed by rollers 320 may help prevent cable 310 from moving in directions that are perpendicular to the center point of cable 310.

In some instances, rollers 320 may be driven by a motor to force cable 310 along a direction. In other instances, a spool around which cable 310 is wrapped may be driven by a motor that pulls cable 310. In such an instance, rollers 320 may allow cable 310 to move without rollers 320 being coupled to a motor that drives rollers 320 to rotate. Rollers 320 may be arranged to pinch and hold cable 310 and to minimize motion of cable in directions perpendicular to a center point of cable 310. Compass 370 includes directions North (N), South(S), East (E), and West (W), these directions are the directions perpendicular to the center point of cable 310.

While the 4 rollers of FIG. 3B are illustrated as being canted at an angle of 45 degrees relative to the N-S and E-W axes of compass 360, such assemblies may include any number of rollers that are canted at angles that help mitigate movement of cable 310 along the N-S and/or E-W axes of compass 360. In certain instances, other guide mechanisms may be used to direct or otherwise control the movement of cable 310. A guide that receives a cable in a recess or trough may be used to constrain movement of cable 310 in directions other than direction 360.

Assemblies designed to retrieve cables from a wellbore may include apparatuses that measure how much cable has been retrieved as cameras or sensors 330 collect data. In one instance, one or more rollers may include metering devices that measure the rotation of the rollers and from these measurements lengths of cable retrieved may be determined. As such measurement devices may be operate like an audiometer of a vehicle. Alternatively, or additionally, data collected by the cameras or sensors 330 may be evaluated by operation of a computer to identify specific locations of a wellbore cable. For example, a computer may be used to identify locations where connectors are located that connect one portion of a power cable with a next portion of that power cable.

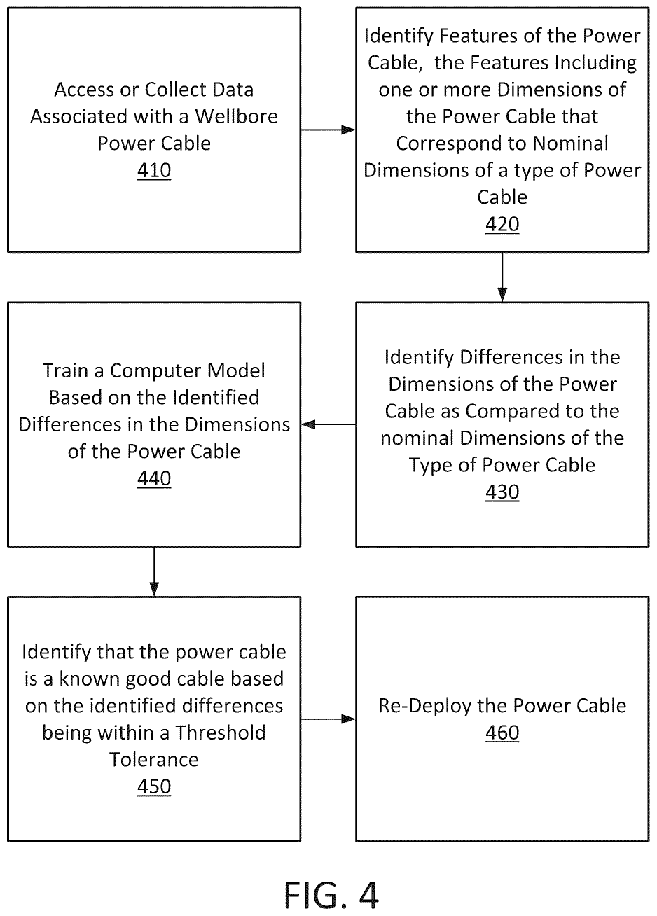

FIG. 4 identifies actions that may be performed by a system that evaluates collected data to identify whether a wellbore power cable meets a use criterion. As discussed in respect to FIGS. 3A and 3B, a power cable may be guided by rollers or other mechanisms as it is being retrieved from a wellbore. One or more sensors may acquire data. This data may then be evaluated to determine whether the power cable has a defect that could affect operation of the power cable or other equipment. Defects may include, but are not limited to: separated or pinched armor, corrosion, electrical burns, or scale buildup. At block 410, data associated with a wellbore power cable may be accessed or collected. This data may have been acquired by one or more cameras and/or other sensors as the power cable is moving. In certain instances, the speed at which the power cable is moved may be varied. Slower motion may result in higher resolutions images being captured as compared to images captured when the cable passes by the sensors at a relatively higher speed. The speed of the cable may be set to controlled within a range of speeds. Data collected by various sensors may itself be image data. For example, a camera natively acquires images from which determinations may be made. In other instances, data from multiple cameras may be used to generate three-dimensional (3D) images of the power cable. In certain instances, collected data may have to be processed when images are generated from this collected data. In an instance when ultrasonic sensors are used, images may be generated from collected data using techniques similar to those used to generate ultrasound images.

At block 420 features of the power cable may be identified. These features may include dimensions of the power cable that correspond to nominal dimensions of a type of power cable. Given the fact that temperatures of the wellbore environment may exceed 200 degrees Celsius (C) and given the fact that cables deployed in the wellbore may be exposed to stresses of various sorts (stretching, thermal expansion and contraction, stresses associated with the cable rubbing along sides of the wellbore, as well as other stresses), the shapes of a cable may become distorted as the cable is used. Stretching, for example could make a cable longer and thinner or heat may cause a cable to expand (cross-sectionally or in length). Furthermore, dirt, scaling, or debris may coat portions of the power cable resulting in a cable being thicker than it really is. Rough surfaces in the wellbore may gouge or cut into a power cable as the cable is moved. As mentioned above, wellbore power cables come in different shapes. These cables may also come in different cross-sectional sizes. Lower gauge (thicker) wires may be used to power a first pump that has a relatively higher power draw and higher gauge (thinner) wires may be used to power a second pump that has relatively lower power draw. How thick a particular wire is may affect how much that particular wire will stretch when exposed to a given stress or load. Each particular power cable used in a wellbore will generally be of one type or another type of power cable. As such, a first pump that consumes 750 KW of power may use a first type of power cable and a second pump that consumes 5 KW of power may use a second type of power cable. To prevent excessive resistive losses and adequately power a given pump, wires of the power cable providing the 750 KW of electrical power to the first pump may be thicker than wires of the power cable providing the 5 KW of power to power the second pump. This means that power cables of different types may have different measurements (e.g., cross sectional widths or circumference). A new power cable will tend to have a size that falls into a range based on manufacturing tolerances of the process used to manufacture that power cable. As such, each respective type of power cable may have different nominal dimensions. Specifications may identify nominal dimensions of a type of power cable. These specifications may also identify tolerances for each type of power cable. For example, a new cylindrical cable may have a specified diameter of 5 inches plus or minus 0.25 inches.

Given the stresses experienced by cables deployed in a wellbore, it may be expected that cables of a specific type that have been deployed in a wellbore will have dimensions that correspond to, yet that are different from, the nominal dimensions of a new cable of that specific type. Once again, this may be because of the mechanical and thermal stresses that the used cable has been exposed to.

In certain instances, the used power cable may have dimensions that are outside of normal or nominal specified dimensions of a new power cable when the used power cable is still functionally good. At block 430, differences in the dimensions of the power cable (e.g., a used power cable) as compared to nominal dimensions of the power cable may be identified. This may include determining measurements of the used cable based on 3D images of the used cable. Nominal dimensions of the type of cable may be stored and referenced when needed or desired. Alternatively, or additionally, the used cable may be measured. These measurements may be compared with a range of acceptable dimensions of a used power cable. In certain instances, a machine-learning (ML) or artificial intelligence (AI) process may learn what such acceptable dimensions are. Initially, a range of cable dimensions may be identified and over time, this range of acceptable dimensions may be updated as the ML or AI process learns (or is trained).

At block 440, the ML or AI process may be trained based on the identified differences in the dimensions or visual appearance of the power cable. In certain instances, the training may allow a system to identify various anomalies that are not necessarily indicative of a good or bad power cable and because of this, the system may identify what is different about one or more portions of the power cable as compared to other portions of the power cable, for example. Repositories of photographic/image data may be collected and individual image data may be labeled. Data may also be collected from failure analysis or engineering reports. Collected and labeled data may be used to enhance operation of an ML or AI process. Such an ML or AI process may also learn based on measurements of pump performance. Data associated with a pump deployed in a wellbore may be collected. This pump may be designed to consume 5 KW of power when pumping a given volume of a fluid. When a three-phase power cable is used, the total power consumed Tp=5 KW=√3*(Voltage)*(Current)*(power factor). In an instance when the voltage=460 Volts and the power factor is 80% (0.80), the current drawn by each phase should be 5000/(√3*460*0.8)=7.8 Amps. Current drawn by each phase may be a function of the impedance (e.g., resistance, inductance, and/or capacitance) of the power distribution line and, as such a cable that has excessive impedance may not work effectively. Systems that evaluate how effectively a power cable distributes power may also measure volumetric flow rates pumped by the pump. A change in current or in flow rates for a given applied voltage may be used to identify whether a give tool or power cable is operating as expected. Such measurements may be performed with the tool (e.g., a pump) and the power cable are deployed in the wellbore. In instances when the current for a given applied voltage pumps an acceptable volume of fluid per unit time, a computer executing the ML or AI process may identify that the power cable deployed in the wellbore is performing adequately.

At block 450, a determination may be made indicating that the power cable is a known good cable. Such determinations may be made based on dimensional thresholds, for example, a nominal dimension plus or minus a threshold distance. At block 460, the power cable may be deployed once again in the same wellbore or in a different wellbore.

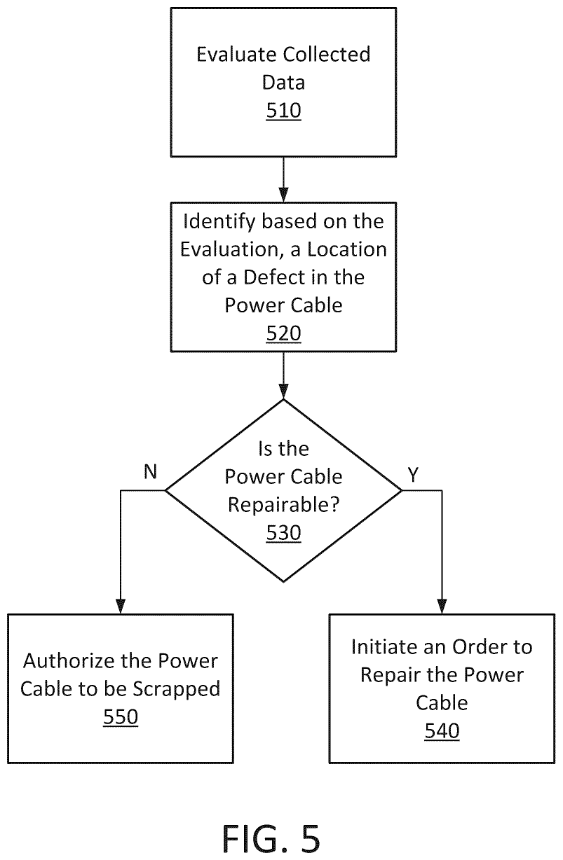

FIG. 5 illustrates actions that may be performed by an automated system when that system determines whether an apparent defect in a power cable can be repaired. At block 510 collected data may be evaluated. At block 520, this evaluation may identify a location of an apparent defect or an anomaly (e.g., a cut or bump) of the cable is located. Determination block 530 may then identify whether the power cable is repairable, when yes, program flow may move to block 540 where an order to repair the power cable is initiated. This may include sending an alert or message to an operator of the wellbore.

When determination block 530 identifies that the cable is not repairable, the cable may be scrapped at block 550.

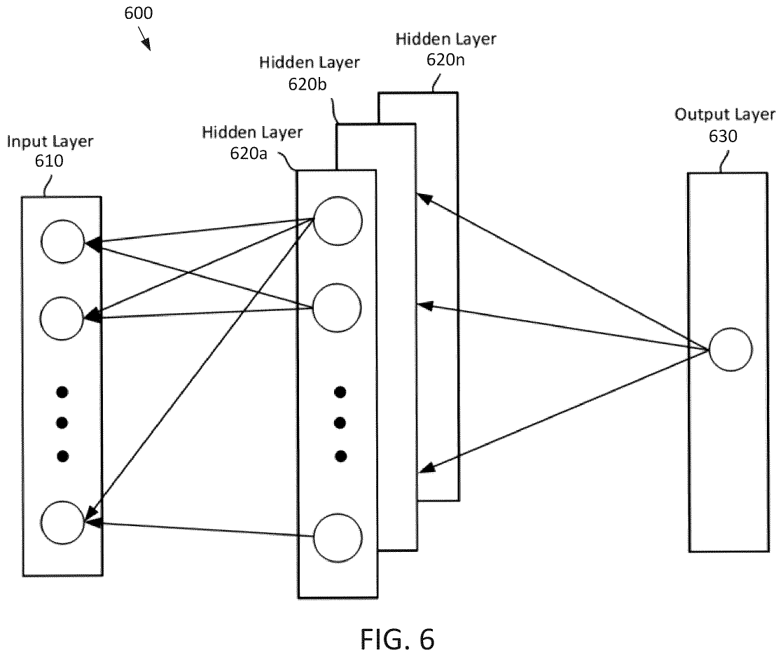

FIG. 6 reviews possible models that can be used to implement a machine-learning or artificial intelligent process of the present disclosure. FIG. 6 is an example of a deep learning neural network 600 that can be used to implement all or a portion of the systems and techniques described herein (e.g., neural network 600 can be used to implement a perception module (or perception system) as discussed above). An input layer 610 can be configured to receive sensor data and/or data relating to an environment. The neural network 600 includes multiple hidden layers 620a, 620b, through 620n. The hidden layers 620a, 620b, through 620n include “n” number of hidden layers, where “n” is an integer greater than or equal to one. The number of hidden layers can be made to include as many layers as needed for the given application. The neural network 600 further includes an output layer 630 that provides an output resulting from the processing performed by the hidden layers 620a, 620b, through 620n.

The neural network 600 may be a multi-layer neural network of interconnected nodes. Each node can represent a piece of information. Information associated with the nodes is shared among the different layers and each layer retains information as information is processed. In some cases, the neural network 600 can include a feed-forward network, in which case there are no feedback connections where outputs of the network are fed back into itself. In some cases, the neural network 600 can include a recurrent neural network, which can have loops that allow information to be carried across nodes while reading in input.

Information can be exchanged between nodes through node-to-node interconnections between the various layers. Nodes of the input layer 610 can activate a set of nodes in the first hidden layer 620a. For example, as shown, each of the input nodes of input layer 610 is connected to each of the nodes of the first hidden layer 620a. The nodes of the first hidden layer 620a can transform the information of each input node by applying activation functions to the input node information. The information derived from the transformation can then be passed to and can activate the nodes of the next hidden layer 620b, which can perform their own designated functions. Example functions include convolutional, up-sampling, data transformation, and/or any other suitable functions. The output of the hidden layer 620b can then activate nodes of the next hidden layer, and so on. The output of the last hidden layer 620n can activate one or more nodes of the output layer 630, at which an output is provided. In some cases, while nodes in the neural network 600 are shown as having multiple output lines, a node can have a single output and all lines shown as being output from a node represent the same output value.

In some cases, each node or interconnection between nodes can have a weight that is a set of parameters derived from the training of the neural network 600. Once the neural network 600 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

In an illustrative example, a metric of interest may be identified and data from a plurality of wells may be accessed and evaluated such that wells with similar characteristics can be classified. In one instance, the metric of interest may be wells that produced greater than a threshold level of oil over a time period or wellbore life. Data from wells that meet this metric may be clustered such that information associated with depths, fluid ratios, pump power, pump efficiency, or other characteristics may be parsed such that an ML system can be further trained. A neural network may be used to classify and cluster data associated with historic wells into appropriate clusters, then use a trained model to classify the new well of interest into one of those clusters. A neural network that performs such classifications may be referred to as a “classification neural network.”

The neural network 600 may be pre-trained to process the features from the data in the input layer 610 using the different hidden layers 620a, 620b, through 620n in order to provide the output through the output layer 630. As such, input layer 610 may receive clustered data and may use the optimization metric (e.g., the wells that produced the greater than the threshold level of oil over the time period or life of the wellbore). Parts that may be used in a new ESP system that were used in similar wells may be identified based on operation of the trained model.

In some cases, the neural network 600 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 600 is trained well enough so that the weights of the layers are accurately tuned.

To perform training, a loss function can be used to analyze errors in the output. Any suitable loss function definition can be used, such as a Cross-Entropy loss. Another example of a loss function includes the mean squared error (MSE), defined as E_total=Σ(½ (target-output)^2). The loss can be set to be equal to the value of E_total.

The loss (or error) will be high for the initial training data since the actual values will be much different than the predicted output. The goal of training may be to minimize the amount of loss so that the predicted output is the same as the training output. The neural network 600 can perform a backward pass by determining which inputs (weights) most contributed to the loss of the network and can adjust the weights so that the loss decreases and is eventually minimized.

The neural network 600 can include any suitable deep network. One example that is commonly used to detect anomalies in the computer vision problem space includes a Convolutional Neural Network (CNN), which includes an input layer and an output layer, with multiple hidden layers between the input and out layers. The hidden layers of a CNN include a series of convolutional, nonlinear, pooling (for down sampling), and fully connected layers. The neural network 600 can include any other deep network other than a CNN, such as an autoencoder, Deep Belief Nets (DBNs), Recurrent Neural Networks (RNNs), among others.

As understood by those of skill in the art, ML based classification techniques can vary depending on the desired implementation. For example, ML classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor or a forecasting-based method. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

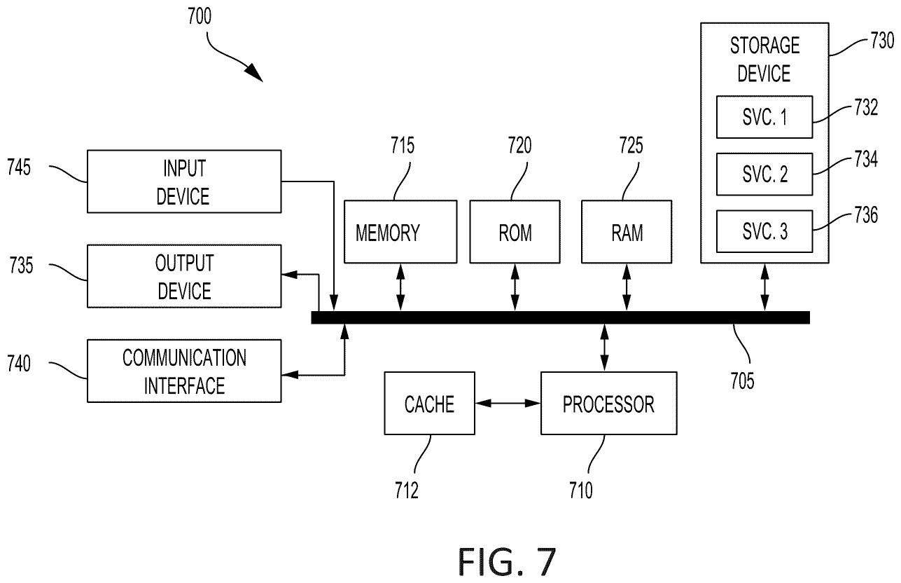

FIG. 7 illustrates an example computing device architecture which can be employed to perform any of the systems and techniques described herein. In some examples, the computing device 700 architecture can be integrated with tools described herein. The components of the computing device architecture 700 are shown in electrical communication with each other using a connection 705, such as a bus. The example computing device architecture 700 includes a processing unit (CPU or processor) 710 and a computing device connection 705 that couples various computing device components including the computing device memory 715, such as read only memory (ROM) 720 and random-access memory (RAM) 725, to the processor 710.

The computing device architecture 700 can include a cache of high-speed memory connected directly with, in close proximity to, or integrated as part of the processor 710. The computing device architecture 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other computing device memory 715 may be available for use as well. The memory 715 can include multiple different types of memory with different performance characteristics. The processor 710 can include any general-purpose processor and a hardware or software service, such as service 1 732, service 2 734, and service 3 736 stored in storage device 730, configured to control the processor 710 as well as a special-purpose processor where software instructions are incorporated into the processor design. The processor 710 may be a self-contained system, containing multiple cores or processors, a bus, memory controller, cache, etc. A multi-core processor may be symmetric or asymmetric.

To enable user interaction with the computing device architecture 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art, such as a display, projector, television, speaker device, etc. In some instances, multimodal computing devices can enable a user to provide multiple types of input to communicate with the computing device architecture 700. The communications interface 740 can generally govern and manage the user input and computing device output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof. The storage device 730 can include services 732, 734, 736 for controlling the processor 710. Other hardware or software modules are contemplated. The storage device 730 can be connected to the computing device connection 705. In one aspect, a hardware module that performs a particular function can include the software component stored in a computer-readable medium in connection with the necessary hardware components, such as the processor 710, connection 705, output device 735, and so forth, to carry out the function.

For clarity of explanation, in some instances the present technology may be presented as including individual functional blocks including functional blocks comprising devices, device components, steps or routines in a method implemented in software, or combinations of hardware and software.

In some instances, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples and aspects thereof, but those skilled in the art will recognize that the application is not limited thereto. Thus, while illustrative examples and aspects of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, examples and aspects of the systems and techniques described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Methods and apparatus of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Such methods may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Statement of the disclosure include:

Statement 1: An apparatus comprising: a memory; one or more processors that execute instructions out of the memory; and one or more sensors that collect data when a wellbore power cable is proximal to the one or more sensors, wherein the one or more processors execute the instructions out of the memory to: identify one or more features of the wellbore power cable along a length of the wellbore power cable, wherein the one or more features of the wellbore power cable include dimensions of the wellbore power cable that correspond to nominal dimensions of a type of power cable, identify based on an evaluation of the data collected by the one more sensors, differences in the dimensions of the wellbore power cable as compared to the nominal dimensions of the type of power cable, and train a computer model based on the identified differences in the dimensions of the wellbore power cable.

Statement 2: The apparatus of statement 1, wherein: the wellbore power cable is identified as a known good cable based on the identified differences being within a threshold tolerance of the nominal dimensions of the type of power cable, and the wellbore power cable is deployed in the wellbore or another wellbore based on the respective dimensions along the length of the wellbore power cable being classified as being the known good cable.

Statement 3: The apparatus of statement 1 or 2, wherein the instructions further cause the one or more processors to: evaluate additional collected data, and identify based on the evaluation on the additional data, a location of a defect in the wellbore power cable.

Statement 4: The apparatus of any of statements 1 through 3, wherein the instructions further cause the one or more processors to identify a measure of stretching of the wellbore power cable.

Statement 5: The apparatus of any of statements 1 through 4, wherein the instructions further cause the one or more processors to identify a potential anomalous condition located at a first location of the wellbore power cable, and wherein at least one feature of the one or more features is identified based on a visual appearance of at least a portion of the wellbore power cable.

Statement 6: The apparatus of any of statements 1 through 5, wherein the instructions further cause the one or more processors to: send an alert to an operator that identifies the potential anomalous condition located at the first location of a/the wellbore power cable, wherein the operator performs a test to identify whether the potential anomalous condition should be classified as a defect of the wellbore power cable.

Statement 7: The apparatus of any of statements 1 through 8, wherein the instructions further cause the one or more processors to identify locations of the cable that are covered by scaling or wellbore debris.

Statement 8: A method comprising: accessing collected data associated with a wellbore power cable, wherein the data was collected when a portion of the wellbore cable was proximal to one or more sensors; identifying one or more features of the wellbore power cable along a length of the wellbore power cable, wherein the one or more features of the wellbore power cable include dimensions of the wellbore power cable that correspond to nominal dimensions of a type of power cable; identifying based on an evaluation of data collected by the one more sensors, differences in the dimensions of the wellbore power cable as compared to the nominal dimensions of the type of power cable, and training a computer model based on the identified differences in the dimensions of the wellbore power cable.

Statement 9: The method of statement 8, further comprising: identifying that the wellbore power cable is a known good cable based on the identified differences being within a threshold tolerance of the nominal dimensions of the type of power cable, and the wellbore power cable is deployed in the wellbore or another wellbore based on the respective dimensions along the length of the wellbore power cable being classified as being the known good cable.

Statement 10: The method of statement 8 or 9, further comprising: evaluating additional collected data; and identifying based on the evaluation of the additional data, a location of a defect in the wellbore power cable.

Statement 11: The method of any of statements 8 through 10, further comprising identifying a measure of stretching of the wellbore power cable.

Statement 12: The method of any of statements 8 through 11, further comprising identifying a potential anomalous condition located at a first location of the wellbore power cable.

Statement 13: The method of any of statements 8 through 12, wherein: an alert is sent to an operator identifying a/the potential anomalous condition located at the first location of the wellbore power cable, and the operator performs a test to identify whether the potential anomalous condition should be classified as a defect of the wellbore power cable.

Statement 14: The method of any of statements 8 through 13, wherein one or more processors execute instructions out of a memory to identify locations of the cable that are covered by scaling or wellbore debris.

Statement 15: A non-transitory computer-readable storage medium having embodied thereon instructions of that when executed by one or more processors: identify one or more features of a wellbore power cable along a length of the wellbore power cable based on an evaluation on data collected by one or more sensors, wherein the one or more features of the wellbore power cable include dimensions of the wellbore power cable that correspond to nominal dimensions of a type of power cable, identify based on an evaluation of the data collected by the one more sensors, differences in the dimensions of the wellbore power cable as compared to the nominal dimensions of the type of power cable, and train a computer model based on the identified differences in the dimensions of the wellbore power cable.

Statement 16: The non-transitory computer-readable storage medium of statement 15, wherein the execution of the instructions by the one or more processors cause the one or more processors to be identified as a known good cable based on the identified differences being within a threshold tolerance of the nominal dimensions of the type of power cable and the wellbore power cable is deployed in the wellbore or another wellbore based on the respective dimensions along the length of the wellbore power cable being classified as being the known good cable.

Statement 17: The non-transitory computer-readable storage medium of statement 15 or 16, wherein the execution of the instructions by the one or more processors cause the one or more processors to: evaluate additional collected data, and identify based on the evaluation on the additional collected data, a location of a defect in the wellbore power cable.

Statement 18: The non-transitory computer-readable storage medium of any of statements 15 through 17, wherein the execution of the instructions by the one or more processors cause the one or more processors to identify a measure of stretching of the wellbore power cable.

Statement 19: The non-transitory computer-readable storage medium of any of statements 15 through 18, wherein execution of the instructions by the one or more processors cause the one or more processors to identify a potential anomalous condition located at a first location of the wellbore power cable.

Statement 20: The non-transitory computer-readable storage medium of any of statements 15 through 19, wherein: an alert is sent to an operator identifying a/the potential anomalous condition located at the first location of the wellbore power cable, and the operator performs a test to identify whether the potential anomalous condition should be classified as a defect of the wellbore power cable.

What is claimed is:

1. An apparatus comprising:
a memory;
one or more processors that execute instructions out of the memory; and
one or more sensors that collect data when a wellbore power cable is proximal to the one or more sensors, wherein the one or more processors execute the instructions out of the memory to:
identify one or more features of the wellbore power cable along a length of the wellbore power cable, wherein the one or more features of the wellbore power cable include dimensions of the wellbore power cable that correspond to nominal dimensions of a type of power cable,
identify based on an evaluation of the data collected by the one more sensors, differences in the dimensions of the wellbore power cable as compared to the nominal dimensions of the type of power cable, and
train a computer model based on the identified differences in the dimensions of the wellbore power cable.

2. The apparatus of claim 1, wherein:
the wellbore power cable is identified as a known good cable based on the identified differences being within a threshold tolerance of the nominal dimensions of the type of power cable, and
the wellbore power cable is deployed in the wellbore or another wellbore based on the respective dimensions along the length of the wellbore power cable being classified as being the known good cable.

3. The apparatus of claim 1, wherein the instructions further cause the one or more processors to:
evaluate additional collected data, and
identify based on the evaluation on the additional data, a location of a defect in the wellbore power cable.

4. The apparatus of claim 1, wherein the instructions further cause the one or more processors to identify a measure of stretching of the wellbore power cable.

5. The apparatus of claim 1, wherein the instructions further cause the one or more processors to identify a potential anomalous condition located at a first location of the wellbore power cable, and wherein at least one feature of the one or more features is identified based on a visual appearance of at least a portion of the wellbore power cable.

6. The apparatus of claim 5, wherein the instructions further cause the one or more processors to:
send an alert to an operator that identifies the potential anomalous condition located at the first location of the wellbore power cable, wherein the operator performs a test to identify whether the potential anomalous condition should be classified as a defect of the wellbore power cable.

7. The apparatus of claim 1, wherein the instructions further cause the one or more processors to identify locations of the cable that are covered by scaling or wellbore debris.

8. A method comprising:
accessing collected data associated with a wellbore power cable, wherein the data was collected when a portion of the wellbore cable was proximal to one or more sensors;
identifying one or more features of the wellbore power cable along a length of the wellbore power cable, wherein the one or more features of the wellbore power cable include dimensions of the wellbore power cable that correspond to nominal dimensions of a type of power cable;
identifying based on an evaluation of the data collected by the one more sensors, differences in the dimensions of the wellbore power cable as compared to the nominal dimensions of the type of power cable, and
training a computer model based on the identified differences in the dimensions of the wellbore power cable.

9. The method of claim 8, further comprising:
identifying that the wellbore power cable is a known good cable based on the identified differences being within a threshold tolerance of the nominal dimensions of the type of power cable, and the wellbore power cable is deployed in the wellbore or another wellbore based on the respective dimensions along the length of the wellbore power cable being classified as being the known good cable.

10. The method of claim 8, further comprising:
evaluating additional collected data; and
identifying based on the evaluation of the additional data, a location of a defect in the wellbore power cable.

11. The method of claim 8, further comprising identifying a measure of stretching of the wellbore power cable.

12. The method of claim 8, further comprising identifying a potential anomalous condition located at a first location of the wellbore power cable.

13. The method of claim 12, wherein:
an alert is sent to an operator identifying the potential anomalous condition located at the first location of the wellbore power cable, and
the operator performs a test to identify whether the potential anomalous condition should be classified as a defect of the wellbore power cable.

14. The method of claim 8, wherein one or more processors execute instructions out of a memory to identify locations of the cable that are covered by scaling or wellbore debris.

15. A non-transitory computer-readable storage medium having embodied thereon instructions of that when executed by one or more processors:
identify one or more features of a wellbore power cable along a length of the wellbore power cable based on an evaluation on data collected by one or more sensors, wherein the one or more features of the wellbore power cable include dimensions of the wellbore power cable that correspond to nominal dimensions of a type of power cable,
identify based on an evaluation of the data collected by the one more sensors, differences in the dimensions of the wellbore power cable as compared to the nominal dimensions of the type of power cable, and
train a computer model based on the identified differences in the dimensions of the wellbore power cable.

16. The non-transitory computer-readable storage medium of claim 15, wherein the execution of the instructions by the one or more processors cause the one or more processors to be identified as a known good cable based on the identified differences being within a threshold tolerance of the nominal dimensions of the type of power cable and, he wellbore power cable is deployed in the wellbore or another wellbore based on the respective dimensions along the length of the wellbore power cable being classified as being the known good cable.

17. The non-transitory computer-readable storage medium of claim 15, wherein the execution of the instructions by the one or more processors cause the one or more processors to:
evaluate additional collected data, and
identify based on the evaluation on the additional collected data, a location of a defect in the wellbore power cable.

18. The non-transitory computer-readable storage medium of claim 15, wherein the execution of the instructions by the one or more processors cause the one or more processors to identify a measure of stretching of the wellbore power cable.

19. The non-transitory computer-readable storage medium of claim 15, wherein execution of the instructions by the one or more processors cause the one or more processors to identify a potential anomalous condition located at a first location of the wellbore power cable.

20. The non-transitory computer-readable storage medium of claim 19, wherein:
an alert is sent to an operator identifying the potential anomalous condition located at the first location of the wellbore power cable, and
the operator performs a test to identify whether the potential anomalous condition should be classified as a defect of the wellbore power cable.
